(19) United States
(12) Patent Application Publication
(10) Pub. No.: US 2023/0170660 A1
(43) Pub. Date: Jun. 1, 2023

(54) LASER SYSTEM FOR NONLINEAR PULSE COMPRESSION AND GRATING COMPRESSOR

(71) Applicant: TRUMPF Laser GmbH, Schramberg (DE)

(72) Inventors: Jonathan Brons, Oberndorf (DE); Raphael Scelle, Villingen-Schwenningen (DE); Dominik Bauer, Rottweil (DE); Aleksander Budnicki, Waldkirch (DE); Alexander Killi, Trossingen (DE); Dirk Sutter, Rottweil (DE); Peter Kroetz, Munich (DE)

(21) Appl. No.: 18/161,904

(22) Filed: Jan. 31, 2023

Related U.S. Application Data
(63) Continuation of application No. PCT/EP2021/070541, filed on Jul. 22, 2021.

(30) Foreign Application Priority Data
Jul. 31, 2020 (DE) 10 2020 209 687.2

(51) Int. Cl. H01S 3/00; G02F 1/35

(52) U.S. Cl. CPC H01S 3/0057; G02F 1/3511; G02F 1/3503

(57) ABSTRACT

A laser system for nonlinear pulse compression includes a laser source configured to generate laser pulses with a pulse energy of at least 50 mJ, a spectral broadening device for spectrally broadening the high-energy laser pulses using self-phase modulation, and a compression device including a grating compressor having at least two diffraction gratings and configured to compress the spectrally broadened high-energy laser pulses. The laser system is configured to generate a pulse duration of the high-energy laser pulses of less than 100 fs.

### CROSS REFERENCE TO RELATED APPLICATIONS

This application is a continuation of International Application No. PCT/EP2021/070541 (WO 2022/023165 A1), filed on Month Jul. 22, 2021, and claims benefit to German Patent Application No. DE 10 2020 209 687.2, filed on Jul. 31, 2020. The aforementioned applications are hereby incorporated by reference herein.

### FIELD

The invention relates to a laser system for nonlinear pulse compression, comprising: a laser source for generating high-energy laser pulses, a spectral broadening device for spectrally broadening the high-energy laser pulses by way of self-phase modulation, and a compression device for compressing the spectrally broadened high-energy laser pulses, the laser system being designed to generate a pulse duration of the high-energy laser pulses of less than 100 fs, preferably of less than 50 fs. The invention also relates to an imaging grating compressor, comprising: two transmission diffraction gratings and an imaging optical unit arranged between the transmission diffraction gratings.

### BACKGROUND

High-energy laser pulses with short pulse durations (high-power laser pulses, for example in the petawatt range) can be used in different fields of application. By way of example, the high-power laser pulses can be focused at a target for the purposes of generating a plasma. The plasma can serve to generate secondary radiation or particle beams, for example as described in more detail in the article “High-Average-Power Ultrafast Lasers”, Optics & Photonics News, October 2017, pages 26ff.

The temporal width of a laser pulse Δτ (pulse duration) is defined in the present application as the temporal width at half the instantaneous, maximum radiant flux in a single laser pulse. The pulse duration Δτ depends on the bandwidth of the laser pulse Δf=Δω/2π in the spectral space. The minimally achievable pulse duration (bandwidth-limited pulse) is inversely proportional to the spectral bandwidth Δτₘᵢₙ∝Δω⁻¹ in this case. To obtain the minimum pulse duration, all spectral components of the electromagnetic field of the laser pulse must be coherently superposed with an optimal, relative phase relationship φ(ω). This spectral phase relationship φ(ω) can be approximated by a Taylor expansion

$${{φ ( ω ) = {φ}_{0} + {φ}^{′} \vert}_{ω = {ω}_{0}} ( ω - {ω}_{0} ) + \frac{1}{2} {φ}^{″} \vert}_{ω = {ω}_{0}} {( ω - {ω}_{0} )}^{2} + …$$

In this case, the symbol ′ represents differentiation with respect to ω. In this case, the zeroth and first order coefficients, φ₀ and φ′|_{ω=ω}_{₀}, are unimportant for the consideration of the pulse duration as they each only bring about a global phase or a linear shift of the overall pulse in the time domain. By contrast, higher order coefficients, φ″|_{ω=ω}_{₀}, φ′″|_{ω=ω}_{₀}, . . . , can influence the pulse duration and pulse shape. The coefficients of second (″) and higher (′ . . . ′) order are abbreviated to β₂, β₃, . . . . Typically, β₂ which causes a linear chirp

$$( - \frac{d ϕ ( t )}{dt} ,$$

with ϕ(t) as temporal phase angle), that is to say stretching in the time domain, and which is also referred to as group delay dispersion (GDD) has the greatest influence. The units of β₂, β₃, . . . are specified in s², s³, . . . . To simplify matters, the dispersion below is understood to mean the GDD (β₂) since the latter has the greatest influence on the phase of the laser pulse.

Optical elements able to impress such phase components β₂/2(ω−ω₀)², β₃/6(ω−ω₀)³, . . . on a laser pulse in order to generate a minimum pulse duration are, for example, what are known as volume Bragg gratings, fiber gratings, dispersive mirrors, prism pairs, diffraction grating pairs, etc.

To reduce the minimum pulse duration of a laser pulse, it is necessary to coherently increase the spectral bandwidth Δω of said laser pulse. One method of achieving this is by way of self-phase modulation (SPM), for example, whereby the temporal phase ϕ(t) is modulated by an intensity-dependent refractive index so that new frequencies are produced in the spectrum and Δω broadens. In this context, the instantaneous (angular) frequency

$$( {ω}_{0} + \frac{d ϕ ( t )}{dt} )$$

varies virtually linearly with time over the majority of a laser pulse, for example in the case of the laser pulse with a Gaussian or sech² form, depending on the pulse form, this being tantamount to a linear chirp. This linear component of the chirp can be compensated by chromatic dispersion, ideally second order (β₂) chromatic dispersion, for example using the aforementioned optically dispersive elements, and the laser pulse can be shortened. For the spectral broadening of highly intensive laser pulses by way of SPM, use is typically made of the cubic nonlinearities in, e.g., gases, crystals or glasses by four-wave mixing (Kerr nonlinearity as a result of a nonlinear refractive index). However, coherent spectral broadening can also be achieved, for example, by cascaded, parabolic nonlinearities within the scope of three-wave mixing, for example by a phase-mismatched generation of the second harmonic—a chirp with an adjustable sign may arise in that case, which chirp also has to be compressed by normal dispersion under certain circumstances, whereas the chirp in the case of spectral broadening in cubic nonlinearities almost exclusively requires anomalous dispersion for compression purposes.

A laser system for nonlinear pulse compression of laser pulses has been disclosed in the article “Compression of high-energy laser pulses below 5 fs”, M. Nisoli et al., Opt. Lett. 22(8), 522-524 (1997). The laser system described therein comprises a laser source which generates laser pulses with a pulse duration of 20 fs and an energy of up to 300 μJ. The laser pulses are input coupled into a spectral broadening device in the form of a quartz glass hollow fiber which has a length of approx. 60 cm and which is filled with argon or krypton in order to broaden the laser pulses by way of self-phase modulation to a spectral bandwidth of up to 250 nm. The laser pulses are subsequently compressed in a compression device comprising a prism compressor for pulse compression by way of chromatic dispersion by refraction in the material of a respective prism and comprising a dispersive mirror compressor (“chirped mirror compressor”) in order to generate pulse durations of less than 5 fs.

The laser system described in the cited article, more precisely its compression device, is not readily scalable to higher pulse energies of the order of mJ: To not exceed the destruction threshold of optical components, comparatively large beam diameters of more than approx. 50 mm, for example, are required at the optical components in the case of such high pulse energies. Therefore, optical components in the form of prisms must be dimensioned to be very large. Moreover, the optical path lengths of the laser pulses traversed in the material of the prisms are comparatively long, having further unwanted, nonlinear effects as a consequence.

The cited article has disclosed the practice of carrying out the compression of laser pulses with the aid of a dispersive mirror compressor, in which the chromatic dispersion is brought about by interference in one or more dispersive mirror coatings; these include, for example, what are known as Gires-Tournois interferometer mirrors or, for example, also what are known as chirped mirrors. In the present application, there is the problem that the bandwidth of the laser pulses following the spectral broadening (which need not necessarily occur in a hollow core fiber) for pulse durations below 100 fs is generally of the order of more than approximately 100 nm. The greater the spectral bandwidth, the smaller the absolute value of the (anomalous or negative) chromatic dispersion generable with the aid of a dispersive mirror. Should a (negative) group delay dispersion β₂ of the order of, for example, approx. −3000 fs² be generated with the aid of dispersive mirrors, a large number of for example 10-15 dispersive mirrors is required to this end on account of the large bandwidth. On account of the large number of dispersive mirrors and on account of the large installation size of the dispersive mirrors due to the power, a compensation device on the basis of a dispersive mirror compressor is not advantageous in the present application.

In the article “Multipass spectral broadening of 18 mJ pulses compressible from 1.3 ps to 41 fs”, M. Kaumanns et al., Optics Letters, Vol. 43, No. 23, pp. 5877-5880, December 2018, a Herriott cell is used as a spectral broadening device in order to generate high-energy laser pulses with a pulse energy of approx. 18 mJ and with pulse durations in the femtosecond range. To test the compressibility of the laser pulses, the laser pulses are led through a compressor with 17 chirped mirrors. The article states that a compression device designed for pulse energies of approx. 18 mJ is currently under development.

### SUMMARY

In an embodiment, the present disclosure provides a laser system for nonlinear pulse compression includes a laser source configured to generate laser pulses with a pulse energy of at least 50 mJ, a spectral broadening device for spectrally broadening the high-energy laser pulses using self-phase modulation, and a compression device including a grating compressor having at least two diffraction gratings and configured to compress the spectrally broadened high-energy laser pulses. The laser system is configured to generate a pulse duration of the high-energy laser pulses of less than 100 fs.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of an exemplary embodiment of a laser system for nonlinear pulse compression of high-energy laser pulses;

FIG. 2a,b show schematic representations of two non-imaging grating compressors, which each have two transmission diffraction gratings;

FIG. 3a,b show schematic representations of two imaging grating compressors, which have two transmission diffraction gratings and two reflection diffraction gratings, respectively;

FIG. 4a,b show schematic representations of a compression device comprising an imaging grating stretcher operated in transmission and a non-imaging grating compressor, the diffraction gratings of which are aligned for the purposes of minimizing a spatial chirp in FIG. 4a;

FIG. 4c shows a schematic representation of a compression device in a manner analogous to FIG. 4a, the compression device additionally comprising two dispersive mirrors; and

FIG. 5a,b show schematic representations analogous to FIGS. 4a,4b with an imaging grating stretcher operated in reflection and a non-imaging grating compressor operated in reflection.

### DETAILED DESCRIPTION

An aspect of the invention is to provide a laser system for nonlinear pulse compression and an imaging grating compressor which enable a compression of laser pulses to short pulse durations of less than 100 fs in the case of very high pulse energies.

In one aspect, a laser system includes a laser source configured to generate the laser pulses with a pulse energy of at least 50 mJ, preferably of at least 100 mJ, in particular of at least 200 mJ, and in which the compression device comprises a grating compressor having at least two diffraction gratings.

Within the meaning of this application, the pulse energy of a laser pulse is understood to mean the instantaneous power of a laser pulse integrated over time or the pulse duration. The mean power of the laser pulses is represented by the product of pulse energy and pulse repetition rate. As described further above, a compression of the spectrally broadened high-energy laser pulses to a pulse duration of less than 100 fs is not readily possible in the case of such high pulse energies.

According to an aspect of the invention, the use of a compression device in the form of a diffraction grating compressor having two or optionally more than two diffraction gratings, which is simply referred to as a grating compressor, for compressing the spectrally broadened high-energy laser pulses is proposed. In principle, non-imaging type and imaging type grating compressors are known.

In the case of a non-imaging grating compressor, a plane-parallel pair of diffraction gratings predominantly adds GDD (β₂) with a negative sign (anomalous or negative dispersion) to the laser pulse. In this context, plane-parallel should be understood in the optical sense, that is to say the diffraction gratings are plane-parallel along the optical axis. In this context, the diffraction gratings are also aligned plane-parallel in the case where the angles between the planes change purely geometrically as a result of one or more folding mirrors. This configuration is also referred to as Treacy type and often used as a compressor. A pair of diffraction gratings tilted with respect to one another with imaging or an imaging optical unit situated therebetween can add chromatic dispersion with a variable sign to a laser pulse by adjusting the spacing between the gratings. Such an optical arrangement can be set or used both as (imaging) grating compressor and as pulse stretcher (this is also known as a Martinez type). In this context, the imaging can also act in magnifying/reducing fashion and the arrangement may contain a reflected double pass-through. A double pass-through is characterized in that the optical system is traversed in mirrored fashion, either by doubling the optical elements or by folding, for example using a retroreflector. A spatial chirp can be avoided as a result of the reflected double pass-through.

Grating compressors with diffraction gratings for compressing laser pulses are known as a matter of principle from chirped-pulse amplification (CPA). However, in that case, very high, typically positive (normal) dispersion (in particular GDD) is added to the pulse in order to stretch the laser pulses in time prior to the amplification, and thus reduce the intensities arising. Accordingly, the (typically negative or anomalous) dispersion is also high, which dispersion needs to be generated by the grating compressor in order to compensate the temporal stretch following the amplification again, and in order hence to compress the laser pulse back to its original, minimal temporal length to the closest possible extent.

However, in the present application only a very small temporal chirp arises as a result of the desired self-phase modulation in the nonlinear, spectral broadening device, corresponding to (positive or normal) chromatic dispersion of the order of, in terms of absolute value, approx. |β₂|<20000 fs². This needs to be compensated with the aid of the compression device. However, the compensation of such a small dispersion is not typical for non-imaging grating compressors: Since the (negative) dispersion increases with increasing distance between the diffraction gratings, the distance between the diffraction gratings is very small for compensating a small (linear) temporal chirp or a (positive) dispersion, typically in the range of a few 100 micrometers to a few millimeters. However, in the case of high powers or pulse energies, large beam diameters (typically several millimeters to several centimeters) and hence large-area diffraction gratings are required so as not to exceed the destruction threshold.

In the Treacy compressor with reflection gratings, the large beams and grating areas require, on account of the installation space, a greater spacing than necessary for compression purposes. The optimal spacing of the gratings could be increased using lower line densities, but this is also significantly to the detriment of the diffraction efficiency of the gratings. The use of conventional, non-imaging reflection grating compressors (of the Treacy type; see above) which have two plane diffraction gratings aligned parallel to one another—in the optical sense—is therefore not readily possible in the case of high-energy laser pulses with pulse energies of more than 50 mJ.

A compressor with parallel transmission grating pairs is also not suitable for this purpose. Although the spacing between the grating planes can be minimized in that case and be brought close to zero (interior grating planes), the then fully compressed beam must in return pass through the transmission diffraction grating substrate downstream of the last grating plane, in which the high peak power of the compressed laser pulse brings about strong, unwanted nonlinear effects such as, e.g., beam quality deterioration and pulse distortion as a result of SPM.

In an embodiment, the grating compressor is designed as an imaging grating compressor. In this case, the grating compressor comprises an imaging optical unit arranged between the two tilted diffraction gratings (see above). In this case, the dispersion is determined by the distance of the second diffraction grating from the image plane of the first diffraction grating. If the distance is optically negative (second grating is struck before the imaging plane by the optical axis), anomalous (negative) dispersion with a negative sign can be added to the laser pulse. In the case of an optically positive distance (second grating is struck by the optical axis only after the image plane of the first grating), the added dispersion is normal (positive) with a positive sign.

In particular, the imaging grating compressor can be designed to generate 4f imaging. In this case, an imaging grating compressor typically comprises two imaging optical elements or element groups, for example lenses or mirrors, which are arranged spaced apart from one another at the distance of their focal lengths. In this case, a first diffraction grating plane (object plane), which extends through the point of intersection of the optical axis of the incident beam with the diffraction grating area and which is aligned perpendicular to the optical axis, is imaged in an image plane which is arranged approximately at a distance from the first diffraction grating plane which corresponds to four times the focal length of the individual imaging elements or element groups. This distance between the first diffraction grating plane (object plane) and the image plane is referred to as 4f below. The distances are measured along the optical axis, which may be interpreted as the beam direction for the central wavelength of the laser pulse. The distances correspond to the optical path length, that is to say a refractive index in the substrate of a transmission diffraction grating that differs from one is taken into account when measuring the distance. A positive deviation (first and second diffraction grating plane are spaced further apart than 4f) from the 4f distance generates a dispersion with a positive sign, while a negative deviation (first and second grating plane are closer together than 4f) from the 4f distance generates a dispersion with a negative sign and acts as a grating compressor. Whether a positive deviation from the 4f distance generates a positive or a negative dispersion depends on the sign with which the input pulse is chirped. Below, the assumption is made that the input pulse has a sign for which the aforementioned relationship between the sign of the deviation from the 4f distance and the sign of the dispersion is given.

The use of 4f imaging in the case of a single pass-through is advantageous as this can avoid foci in the optical elements. Magnifying imaging in the single pass-through is typically problematic and the double pass-through is also made more difficult as a result of nonlinearities. The diffraction gratings need not be arranged symmetrically with respect to the optical elements of the 4f imaging optical unit, that is to say the alignments (angles) in relation to the optical axis and/or the distances from the respective imaging planes may differ from one another for said diffraction gratings.

The use of an imaging grating compressor was found to be advantageous since the imaging optical unit allows the compensation of even a (linear) temporal chirp with a comparatively small absolute value or a (positive) dispersion generated by self-phase modulation. By way of example, a negative dispersion β₂ which, in terms of absolute value, has a small value of for example less than 10 000 fs² can be set in the case of a grating compressor by way of a suitable (negative) deviation of the spacings between the grating planes from the 4f imaging used therein.

In a development, the imaging grating compressor comprises two reflection diffraction gratings. On account of the imaging properties of the grating compressor, the diffraction gratings are arranged at a comparatively large distance from one another such that input coupling of the laser pulses between the reflection diffraction gratings is possible without problems, in contrast to a non-imaging grating compressor. In this configuration of the grating compressor, the laser pulses do not pass through the respective substrate of the diffraction grating, and so there is no unwanted nonlinear phase shift (B-integral) as a result of self-phase modulation in the respective substrates.

The B-integral is defined as

$$B = \frac{2 π}{λ} {\int }_{0}^{l} {n}_{2} {I}_{0} ( z ) dz$$

where l denotes the length traversed by the laser pulse along the beam axis in the material, A denotes the mean wavelength of the laser pulse, n₂ denotes the nonlinear refractive index of the traversed material, and I₀(z) denotes the peak intensity of the laser pulse along the beam axis.

In an alternative development, the imaging grating compressor comprises two transmission diffraction gratings, with the transmission diffraction gratings preferably being attached to an exit-side side of a respective transparent substrate. An imaging grating compressor comprising transmission diffraction gratings typically leads to smaller aberrations in the beam profile in the case of high average powers than is the case for an imaging grating compressor with reflection diffraction gratings.

In this embodiment, the first transmission diffraction grating in the beam path of the laser pulses is attached to an exit-side side of the transparent substrate since there would be a compression of the laser pulses in the material of the substrate in the case of an attachment to the entrance-side side of the substrate. The second transmission diffraction grating in the beam path is likewise formed at an exit-side side of a transparent substrate because the nonlinear phase shift (B-integral) would otherwise be too large and a compression would not be readily possible.

In an alternative embodiment, the compression device comprises a stretching device, preferably in the form of a grating stretcher having at least two diffraction gratings, in particular in the form of an imaging grating stretcher, for temporally stretching the laser pulses. In this embodiment, the (positive) dispersion of the laser pulses is increased in terms of absolute value with the aid of a diffraction grating stretcher, which is simply referred to as a grating stretcher, such that the grating compressor can generate or compensate a greater (negative) dispersion in terms of absolute value. In this way, even non-imaging grating compressors (Treacy type compressors or else parallel transmission grating pairs) can be used for the present application, which non-imaging grating compressors could not be used or only had restricted use on account of the small temporal chirp or the small (positive) dispersion in terms of absolute value to be compensated, which is generated by the self-phase modulation. The grating stretcher typically generates a (positive) dispersion β₂ of the order of more than +2000 fs², optionally of more than +10 000 fs².

In a further embodiment, the grating compressor is designed as a non-imaging grating compressor. In the unfolded state, such a grating compressor typically comprises two plane diffraction gratings aligned parallel to one another (so-called Treacy type), which diffraction gratings would have to have a small distance from one another for the purposes of compensating a small temporal chirp or a (positive) dispersion with a small absolute value. Should the beam path be folded at additional optical elements, the diffraction gratings or the grating planes may also be aligned not parallel to one another. The spacing of the diffraction gratings required for the compression—without a preceding stretch by an additional dispersive element—is typically only a few hundred micrometers to a few millimeters. As a result of the additional (positive) dispersion generated by the stretching device, it is possible to also use such a non-imaging grating compressor for the compression of the high-energy laser pulses that have been spectrally broadened as a result of self-phase modulation.

In an embodiment, the non-imaging grating compressor comprises two reflection diffraction gratings. On account of the absolute-value magnification of the (positive) dispersion with the aid of the grating stretcher, the two reflection diffraction gratings may be arranged at a comparatively large distance from one another, promoting or even only allowing the input coupling of the laser pulses between the two reflection diffraction gratings.

In an alternative embodiment, the non-imaging grating compressor comprises two transmission diffraction gratings and preferably is arranged in the beam path downstream of the stretching device. The use of transmission diffraction gratings typically leads to smaller aberrations in the beam profile in the case of high average powers than is the case for reflection diffraction gratings. As a result of stretching the laser pulses or as a result of generating the (positive) dispersion in the stretching device in the beam path upstream of the grating compressor, there can be a continuous pulse shortening along the length of the grating compressor in this case. The highest intensities therefore only occur in the short last interaction portion (<mm) within the last transmission diffraction grating substrate, and so the thickness of a respective transparent substrate plays a subordinate role for the undesired self-phase modulation generated in the grating compressor substrate. The self-phase modulation in the substrates is only minimal in this case, and so the compressibility upstream or downstream of the transmission diffraction gratings continues to exist virtually unchanged. Therefore, use can also be made of comparatively thick transparent substrates without generating significant unwanted effects in the diffractive grating substrate as a result of self-phase modulation.

In a further embodiment, a first transmission diffraction grating of the grating compressor in the beam path is attached to an exit-side or entrance-side side of a first transparent substrate and a second transmission diffraction grating of the grating compressor in the beam path is attached to an exit-side side of a second transparent substrate. Attaching the second transmission diffraction grating to the exit-side side of the second transparent substrate is advantageous because significantly self-phase modulation would already be generated again in the case of an attachment to the entrance-side side of the second transparent substrate. The latter spectrally broadens the already compressed laser pulse, that is to say there is a deterioration in the beam quality and a change in the temporal phase, and so a subsequent, further compressor would be required under certain circumstances. Attaching the transmission diffraction grating to the exit-side side of the first transparent substrate is preferable to the attachment to the entrance-side side. It is likewise possible to attach the transmission diffraction grating to the entrance-side side of the first transparent substrate, especially if the stretching device brings about a sufficient stretch of the laser pulses.

To minimize the self-phase modulation in the first transmission diffraction grating substrate of the grating compressor, it is advantageous in the two above-described cases to set significant stretching of the laser pulse by way of positive dispersion by means of the stretching device disposed upstream in the beam path, preferably by at least a factor of 2 and ideally by at least a factor of 10 in relation to the pulse duration of the laser pulse upon entry into the stretching device.

In a further embodiment, the grating stretcher comprises at least two reflection diffraction gratings. The grating stretcher and the grating compressor is arranged as desired in the beam path, that is to say the grating compressor may also be arranged upstream of the grating stretcher in the beam path, especially in the case where even the non-imaging diffraction grating compressor only comprises reflection diffraction gratings. By way of example, a Treacy-type grating compressor operated in reflection can be used to generate a negative dispersion, in which grating compressor there cannot be any compression in the substrate on account of the structure and which grating compressor is followed in the beam path by a grating stretcher operated in transmission which generates a positive dispersion of optimal compression on the exit side.

In an alternative embodiment, the imaging grating stretcher comprises at least two transmission diffraction gratings, with preferably a first transmission diffraction grating in the beam path being attached to an exit-side side of a first transparent substrate and with preferably a second transmission diffraction grating in the beam path being attached to an entrance-side side of a second transparent substrate. In contrast to the imaging grating compressor with transmission diffraction gratings described further above, the second transmission diffraction grating may be attached to the entrance-side side of the second transparent substrate in the case of the imaging grating stretcher since the laser pulses are temporally stretched in this case and the influence of the nonlinearities in the substrate is therefore negligible). However, it is also possible as a matter of principle for the second transmission diffraction grating in the beam path to be attached to an exit-side side of the second transparent substrate should the laser pulse have already been sufficiently stretched in time upon entrance into the substrate in order to avoid self-phase modulation, or should the substrate not be too thick.

In a further embodiment, the diffraction gratings of the grating compressor and the diffraction gratings of the grating stretcher are aligned relative to one another for the purposes of minimizing a spatial chirp. In the case of a single pass-through through a pair of diffraction gratings, there is a split of the laser pulses into their spectral components, and these propagate with a spatial offset but in parallel following the single pass-through; this is also referred to as a spatial chirp. As a rule, the deterioration in the beam quality as a result of the spatial chirp is negligible in the present application, in which there is only a comparatively minor adjustment of the dispersion, but it generally depends on the grating constant or the line density of the diffraction gratings, the spacing of the diffraction gratings, and the spectral bandwidth of the laser pulse.

The spatial chirp generated by a pair of diffraction gratings in the case of a single pass-through can be compensated by a double pass-through through the pair of diffraction gratings, for example when a retroreflector is used. In the present case, the spatial chirp is minimized by a further pair of diffraction gratings, which generates an opposite spatial chirp of similar magnitude. The two pairs of diffraction gratings of the grating compressor and of the grating stretcher are arranged or aligned with respect to one another in such a way here that the spatial chirp generated by the first pair of diffraction gratings is almost or substantially compensated, and hence minimized, by the second pair of diffraction gratings. This is the case should the second pair of diffraction gratings act or be aligned as if there would virtually be a double pass-through through the first pair of diffraction gratings, with one of the two pairs of diffraction gratings having an imaging structure.

In the case of the single imaging compressor, the spatial chirp is proportional to the compensated dispersion (distance of the second diffraction grating from the image plane of the first diffraction grating). In the case of a small dispersion and, moreover, large beam diameters, the arising spatial chirp is negligibly small (even subsequently in the focus). The single imaging grating compressor (without double pass-through) automatically minimizes the spatial chirp.

In the case of a combination of grating stretcher and grating compressor, the added net overall dispersion is also relevant to the spatial chirp, which is just as small as in the case of the imaging compressor. Therefore, the spatial chirp is also negligibly small in this case, but only for the case that the grating compressor and the grating stretcher, more precisely their diffraction gratings, are arranged or aligned the right way round relative to one another. If they are arranged the wrong way round, the spatial chirp of the two add up, and this in turn may be significant as there optionally should be significant stretching. If the grating stretcher and the grating compressor would each be passed through in the double pass-through, no spatial chirp would be generated by any component.

In a further embodiment, the compression device comprises at least one dispersive mirror. As described further above, the use of a compression device comprising only dispersive mirrors tends not to be suitable for the present application on account of the large number of dispersive mirrors and, due to manufacturing reasons, the restricted size thereof (avoidance of laser-induced damage). However, it may be advantageous for the compression device to comprise one or more dispersive mirrors, for example two or three dispersive mirrors, in addition to the grating compressor as said mirrors may optionally compensate or generate higher order dispersion effects, which cannot be compensated for, or can only be compensated for with difficulties, by means of diffraction gratings. The dispersive mirror or mirrors can also be used to compensate a residual dispersion that is not compensated for by the grating compressor. The dispersive mirror or mirrors can typically be arranged in the beam path upstream or downstream of the grating compressor.

The spectral broadening device can be designed for spectral broadening of the high-energy laser pulses by at least a factor of 5 or 10. The spectral broadening by a factor of 5 or 10 or more, typically by a factor of approx. 10 to approx. 30, is implemented, as a rule, in a spectral broadening device in the form of a multi-pass cell, for example in the form of a Herriott cell, by way of self-phase modulation, as described in the article in Optics Letters cited at the outset, in U.S. Pat. No. 9,847,615B2 or in DE 10 2020 204 808.8, each of which is included in its entirety in the content of this application by reference. The embodiment of a spectral broadening device described in DE 10 2020 204 808.8, which uses individual mirror elements in place of two monolithic mirror elements (conventional Herriott cell) for the deflection is advantageous as more circulations through the cell can be realized in this way than with a conventional Herriott cell arrangement. The laser pulses generated by the laser source generally have a full width at half maximum spectral bandwidth of the order of approx. 0.2 THz to approx. 15 THz.

In a further embodiment, the laser source is designed to generate the high-energy laser pulses with a pulse duration of 300 fs or more, preferably 500 fs or more. The laser source can be a laser amplifier system which is designed to generate laser pulses with a pulse energy of 50 mJ or more and with a pulse duration in the value range specified above. To this end, the laser system may comprise a dedicated pulse compressor.

It is possible that the spectral broadening device and the compression device are followed in the beam path by (at least) one further spectral broadening device and (at least) one further compression device, in order to further compress the laser pulses. In this case, the laser system comprises a cascaded arrangement with (at least) two pairs of spectral broadening device and compression device.

Multiple passages through a single spectral broadening device and a single compression device are also possible, for example in order to shorten laser pulses with a relatively long pulse duration. In this case, the laser pulses with a pulse duration which can be of the order of 1000 fs, for example, may pass initially through the spectral broadening device and then through the compression device in a first pass. In a second passage, the laser pulses—typically following a rotation of the polarization direction using a retardation plate, for example a quarter wave plate—initially pass through the compression device (a pulse duration of approx. 100 fs, for example) and then pass through the spectral broadening device. Following the second passage, the laser pulses can be deflected at a polarizing beam splitter, for example, to a further compression device, which further reduces the pulse duration, for example to approx. 30 fs. In this way it may optionally be possible to economize a spectral broadening device.

In a further embodiment, the imaging grating compressor and/or the imaging grating stretcher is/are arranged in a chamber with vacuum surroundings and/or with protective gas surroundings. Especially in the case of the imaging grating compressor or the imaging grating stretcher, it was found to be advantageous if these are arranged in vacuum surroundings or in protective gas surroundings as these optionally generate an intermediate focus during the imaging, and the power density of the high-energy laser pulses is very high there, and so a plasma is undesirably generated there under certain circumstances.

In principle, it was found to be advantageous for the present application if the overall beam guidance, that is to say in particular the optical components of the compression device and, as a rule, also the optical components of the spectral broadening device are arranged in vacuum surroundings or in surroundings with a reduced pressure vis-à-vis atmospheric pressure since the propagation of the laser pulses through a gas or through air leads to unwanted self-phase modulation.

A further aspect of the invention relates to an imaging grating compressor of the type specified at the outset, in which the transmission diffraction gratings are attached to an exit-side side of a respective transparent substrate. In contrast to a conventional imaging grating compressor, both transmission diffraction gratings are attached to or formed at the respective beam-exit-side side of the transparent substrate in the grating compressor according to the invention. In this way, the nonlinear phase (B-integral) accumulated in the grating compressor can be minimized. An imaging grating compressor comprising transmission diffraction gratings typically leads to smaller aberrations in the beam profile in the case of high average powers than is the case for an imaging grating compressor with reflection diffraction gratings.

As described further above in the context of the imaging grating compressor, the two transmission diffraction gratings are arranged tilted with respect to one another. The dispersion is determined by the distance of the second grating from the image plane of the first grating. In the case of the grating compressor described here, the distance is optically negative (the second grating is struck by the optical axis upstream of the imaging plane), and so anomalous (negative) dispersion with a negative sign can be added to the laser pulse, that is to say the latter is compressed. As likewise described further above, it is advantageous if the imaging grating compressor generates 4f imaging or has an imaging scale of 1:1.

Further advantages of the invention are evident from the description and the drawing. Likewise, the features mentioned above and those that will also be presented further can be used in each case by themselves or as a plurality in any desired combinations. The embodiments shown and described should not be understood as an exhaustive enumeration, but rather are of exemplary character for outlining the invention.

In the following description of the drawings, identical reference signs are used for identical or functionally identical components.

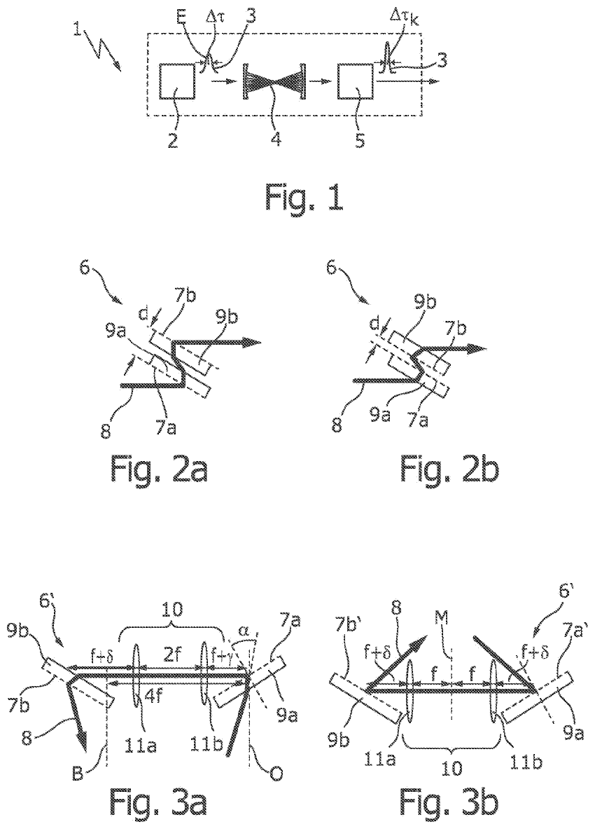

FIG. 1 shows an exemplary structure of a laser system 1 for nonlinear pulse compression. The laser system 1 represented by a dashed frame in FIG. 1 comprises a laser source 2 for generating high-energy laser pulses 3, a spectral broadening device 4 for spectrally broadening the high-energy laser pulses 3 by way of self-phase modulation, and a compression device 5 for compressing the spectrally broadened high-energy laser pulses 3 to a pulse duration Δτₖ of less than 100 fs, more particularly of less than 50 fs. The compressed laser pulses 3 with the pulse duration of less than 100 fs emerge from the laser system 1 and can be used for various applications. By way of example, the laser pulses 3 can be focused at a target not depicted here, in order to generate secondary radiation, for example in the form of EUV radiation. The pulse energy E of the laser pulses 3 is reduced during the passage through the laser system 1 downstream of the laser source 2 on account of losses that are typically of the order of approx. 5%-20%, that is to say the laser pulses 3 have a slightly lower pulse energy E upon the exit from the laser system 1, but this pulse energy may likewise be at least 50 mJ, 100 mJ, at least 200 mJ or more.

In principle, it is possible for the laser system 1 to comprise at least one further spectral broadening device and at least one further compression device, which are arranged downstream of the structural broadening device 4 and downstream of the compression device 5 (cascading). Multiple passages of the laser pulses 3 through the spectral broadening device 4 and through the compression device 5 are likewise possible.

In the example shown, the laser source 2 is designed to generate the high-energy laser pulses 3 with a pulse energy E of at least 50 mJ, at least 100 mJ or at least 200 mJ. Laser sources 2 for generating high-energy laser pulses 3 with such pulse energies E are known as a matter of principle and usually have a suitably designed laser amplifier system for this purpose. By way of example, the high-energy laser pulses 3 may have a wavelength of the order of approx. 1000 nm, but longer or shorter wavelengths are also possible.

The laser source 2 generates the high-energy laser pulses 3 with a pulse duration Δτ which is of the order of 100 fs or more, for example with a pulse duration Δτ of 300 fs or more, or of 500 fs or more. In the example shown, the spectral bandwidth of the laser pulses 3 is of the order of approx. 3 Thz, but may optionally also be greater or smaller. The bandwidth of the high-energy laser pulses 3 is broadened at least 5-fold by self-phase modulation in the spectral broadening device 4, that is to say a spectral bandwidth Δf of the high-energy laser pulses 3 of 3 THz, for example, is broadened by the spectral broadening device 4 to a spectral bandwidth Δf of at least 15 THz. Typical values for the factor of the spectral broadening are of the order of between five and thirty.

In the example shown, the spectral broadening device 4 is designed as a multipass cell, more precisely as a Herriott cell. The spectral broadening is implemented by self-phase modulation. By defining the distance between the two mirrors of the Herriott cell and by defining further parameters, it is possible to specify the factor of spectral broadening which is generated by the spectral broadening device 4 in the form of the Herriott cell. The pulse shape of the laser pulses 3 and, in particular, the pulse duration Δτ of the laser pulses 3 remains practically unchanged by the nonlinear interaction in the form of the self-phase modulation in the spectral broadening device 4. Instead of a conventional Herriott cell, the spectral broadening device 4 may also be designed as described in DE 10 2020 204 808.8, that is to say it may comprise a plurality of individual mirror elements in place of two monolithic mirror elements, the individual elements being fastened to a respective main body in order to increase the number of passages through the cell.

The spectrally broadened high-energy laser pulses 3 are supplied to the compression device 5, which is designed to shorten the high-energy laser pulses 3 to a pulse duration Δτₖ of less than 100 fs, in particular of less than 50 fs. The compression device 5, more precisely its (linear) optical elements (diffraction grating, dispersive mirrors, etc.) do not modify the spectrum of the laser pulses 3, but shorten/stretch the laser pulses 3 in the time domain. The compression device 5 also serves to compensate the temporal chirp of the high-energy laser pulses 3 which is generated by the spectral broadening device 4, by virtue of the compression device generating a (negative or anomalous) dispersion of equal magnitude. The temporal (linear) chirp generated by the self-phase modulation in the spectral broadening device 4 can be compensated by a (negative) dispersion ⊕β₂| of the same order of magnitude, that is to say of approx. −10 000 fs². Compensating spectrally broadened laser pulses 3 with a spectral bandwidth of generally more than 30 THz at the required large beam diameters with the aid of a compression device 5 formed from dispersive mirrors is difficult to solve from a technical point of view as a multiplicity of very large mirrors are required.

The use of a compression device 5 in the form of a non-imaging grating compressor 6, as depicted in exemplary fashion in FIGS. 2a,b, is not readily suitable for this purpose either: The non-imaging grating compressor 6 depicted in FIGS. 2a,b comprises two plane transmission diffraction gratings 7a,b, which are aligned parallel to one another and are arranged spaced apart from one another by a distance d. The distance d specifies the absolute value of the (negative) dispersion that can be generated by the grating compressor 6. The shorter the distance d, the smaller the (negative) dispersion of the grating compressor 6. A comparatively small distance d between the transmission diffraction gratings 7a,b is required for the purposes of compensating the aforementioned spatial chirp which is generated by the self-phase modulation in the spectral broadening device 4 and which is of the order of approx. +10 000 fs². As a rule, the laser pulse experiences a significantly uncontrolled self-phase modulation in a respective transparent substrate 9a, 9b in the case of the sought-after pulse energies, and it is not possible to compress modulation and the beam quality deteriorates.

In the example depicted in FIG. 2a, the first transmission diffraction grating 7a is formed at an entrance-side side of a first transparent substrate 9a in the beam path 8 of the laser pulses 3 and the second transmission diffraction grating 7b is formed at an exit-side side of a second transparent substrate 9b in the beam path 8 of the laser pulses 3. Consequently, the two transparent substrates 9a, 9b are arranged between the transmission diffraction gratings 7a, 7b in the example shown in FIG. 2a. On account of the large beam diameters of the high-energy laser pulses 3, a thickness of the substrates 9a, 9b of approx. 5 mm is required, and so the distance d is approx. 10 mm. However, such a value for the distance d is too large to generate a sufficient compression in the case of the grating line densities of the two transmission diffraction gratings 9a,b required to generate a sufficient transmission (e.g., >90%). Moreover, the laser pulses 3 are already compressed upon entrance into the first substrate 9a, leading to an unwanted Kerr lens or a nonlinear phase of the high-energy laser pulses 3.

In the grating compressor 6 depicted in FIG. 2b, the two transmission diffraction gratings 7a, 7b are formed on facing sides of the two transparent substrates 9a, 9b. Accordingly, the distance d between the two transmission diffraction gratings 7a, 7b can be chosen to be smaller than what is the case for the grating compressor 6 depicted in FIG. 2a, and the distance can be approximately d=1 mm, for example. However, the problem with the grating compressor 6 shown in FIG. 2b is that the compression of the high-energy laser pulses 3 has already been completed upstream of the second substrate 9b. As a result, the second substrate 9b distorts the high-energy laser pulses 3 that have already been compressed to the desired pulse duration Δτₖ of approx. 30 fs, modifies the phase of said laser pulses and reduces the beam quality thereof. The grating compressor 6 shown in FIG. 2b would therefore optionally require a further compressor downstream in the beam path 8 in order to at best compensate the temporal distortion.

To avoid the problems described in the context of the non-imaging grating compressor 6 described in FIGS. 2a,b, an imaging grating compressor 6′, which is described in FIG. 3a, can be used as compression device 5, for example in the laser system 1 of FIG. 1. The grating compressor 6′ depicted in FIG. 3a differs from the non-imaging grating compressor 6 shown in FIGS. 2a,b in that an imaging optical unit 10 is arranged between the two transmission diffraction gratings 7a, 7b. In the example shown, the imaging optical unit 10 is designed to generate 4f imaging and comprises two imaging optical elements 11a,b, depicted in the form of lenses in exemplary fashion, for this purpose. It is understood that other imaging optical elements 11a,b, for example mirrors or the like, may also be used in place of lenses for the purposes of realizing the 4f imaging or any other type of imaging; cf., for example, the article “Transmission grating stretcher for contrast enhancement of high power lasers”, Yuxin Tang et al., Opt. Expr. Vol. 22, No. 24, 2014.

As may likewise be identified in FIG. 3a, the two lenses 11a,b are arranged at a distance which corresponds to twice the focal length f of a respective lens 11a,b. In the case of a collimated beam path, an intermediate focus arises in the middle between the two lenses 11a,b during the imaging. In the example shown, the two transmission diffraction gratings 7a, 7b are respectively arranged at distances f+δ and f+γ from the respectively adjacent lens 11a,b. In this case, the distance f+δ or f+γ does not correspond to the geometric path length but the optical path length along the optical axis. This means that the refractive index of the second substrate 9b but not the geometric change in direction upon entrance into the second substrate 9b is taken into account when determining the distance f+δ.

The sum of the deviations δ+γ, which determines the dispersion, can more generally also be defined as the (optical) distance of the second transmission diffraction grating 9b (or its diffraction grating plane) from an image plane B, in which a first diffraction grating plane (object plane O) of the first transmission diffraction grating 9a is imaged. As is evident in FIG. 3a, the object plane O or the first diffraction grating plane extends through the point of intersection of the optical axis with the first transmission diffraction grating 7a and is oriented perpendicular to a section of the optical axis between the two transmission diffraction gratings 7a, 7b. The image plane B is arranged at a distance from the object plane O which corresponds to approximately four times the focal length (4 f) of the individual lenses 11a, 11b. It is understood that the two lenses 11a, 11b of the imaging optical unit 10 need not necessarily have the same focal length f but may also have different focal lengths.

The sign of the sum of the deviations δ+γ from twice the focal length 2 f is negative (i.e., (δ+γ)<0) in the example shown in FIG. 3a. This causes the generation of negative dispersion, and so the optical arrangement shown in FIG. 3a acts as a grating compressor 6.

The deviation δ+γ can be chosen to be very small in the imaging grating compressor 6′ of FIG. 3a, in order to compensate a minor temporal chirp without the problem described in conjunction with the non-imaging grating compressor 6 of FIGS. 2a,b occurring in the process. As is likewise evident from FIG. 3a, the two transmission diffraction gratings 7a, 7b are in each case formed on or applied to an exit-side side of the first and the second transparent substrate 7a, 7b, respectively. As a result, it is possible to achieve that the high-energy laser pulses 3 are not already compressed in the first substrate 9a and/or that the B-integral or the unwanted nonlinear effects do not become too high in the second substrate 9b and thereby renders the compression impossible. In the example shown, the angle of incidence a of the high-energy laser pulses 3 on the first transmission diffraction grating 7a is approx. 25°, but can also be chosen to be greater or smaller.

FIG. 3b shows an imaging grating compressor 6′ which differs from the grating compressor 6′ depicted in FIG. 3a in that the former has two reflection diffraction gratings 7a′, 7b′. As a rule, it is not possible to use reflection diffraction gratings 7a′, 7b′ in the case of a non-imaging grating compressor 6 because input coupling of the high-energy laser pulses 3 between the two reflection diffraction gratings 7a′, 7b′ is typically not possible on account of the small distance d between the reflection diffraction gratings 7a′, 7b′ and the comparatively large beam diameter (w₀) of approx. 20 mm, for example, on account of the power. In the case of the imaging grating compressor 6′ shown in FIG. 3b, the two reflection diffraction gratings 7a′, 7b′ are arranged at the same distance from a central plane M. The distances of the respective reflection diffraction gratings 7a′, 7b′ from the respectively adjacent lens 11a, 11b are the same (i.e., the following applies: δ=γ). The following illustrations also depict a symmetric arrangement of the diffraction gratings 7a, 7b, 7a′, 7b′ with respect to a central plane M; however, it is understood that a non-symmetric arrangement, as depicted in FIG. 3a, is also possible.

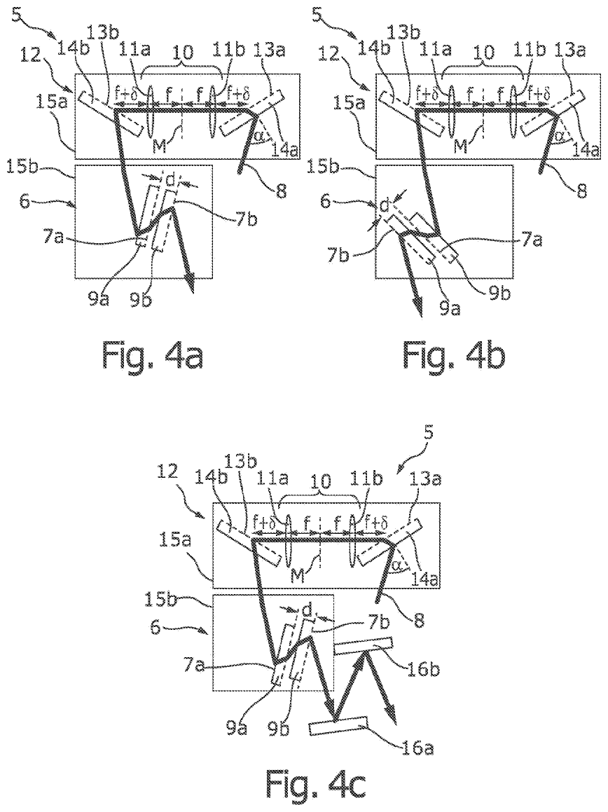

FIGS. 4a-c show an alternative embodiment of the compression device 5 of FIG. 1 which comprises a stretching device in the form of an imaging grating stretcher 12 for temporally stretching the high-energy laser pulses 3, in addition to a transmissive, non-imaging grating compressor 6. The imaging grating stretcher 12 is arranged upstream of the non-imaging grating compressor 6 in the beam path 8. In terms of its structure, the grating stretcher 12 substantially corresponds to the imaging grating compressor 6′ depicted in FIG. 3a, that is to say it comprises an imaging optical unit 10 for generating 4f imaging and two transmission diffraction gratings 13a,b, which are each attached to a transparent substrate 14a, 14b.

In the case of the symmetric grating stretcher 12, the deviation δ of the distance f+6 between the respective transmission diffraction grating 12a,b and the adjacent imaging optical element 11a,b from the focal length f has a positive sign in order to generate positive dispersion. Moreover, the second transmission diffraction grating 13b is formed at the entrance-side side of the second transparent substrate 14b in the case of the imaging grating stretcher 12. This is possible because, in contrast to FIG. 3a, no undesired compression is generated in the second transparent substrate 13b in this case. In the case where the grating stretcher 12 generates sufficient temporal stretching of the laser pulses 3, the second transmission diffraction grating 13b may also be formed at the exit-side side of the second transparent substrate 14b.

The grating stretcher 12 generates (positive) dispersion of the high-energy laser pulses 3 and this avoids the problem described further above in the context of FIGS. 3a,b since there may be continuous pulse shortening along the length of non-imaging grating compressor 6. Highest intensities therefore only occur in the short last interaction portion (<mm), and so the thickness of a respective transparent substrate 9a, 9b of the grating compressor 6 plays a subordinate role. The self-phase modulation by the high-energy laser pulses 3 in the two transparent substrates 9a,b is only minimal in this case, and so the compressibility upstream or downstream of the transmission diffraction gratings 7a, 7b exists unchanged. As a result, it is also possible to use comparatively thick transparent substrates 9a, 9b without significantly increasing the B-integral or the unwanted nonlinear effects. The distance d between the transmission diffraction gratings 7a, 7b can be increased to values of the order of approx. 10 mm or more in relation to the case shown in FIGS. 2a,b—depending on the pulse stretching or dispersion generated by the grating stretcher 12.

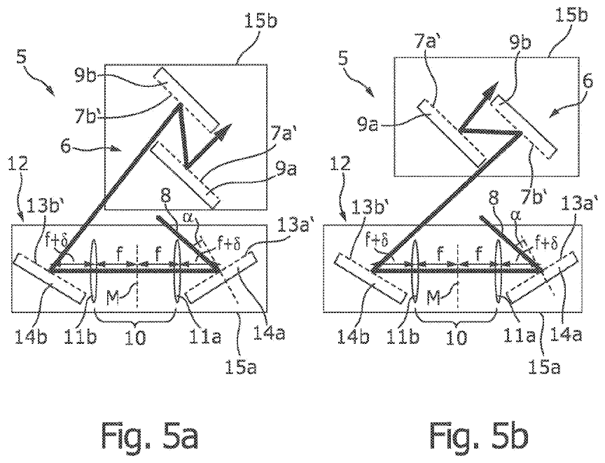

The non-imaging grating compressor 6 shown in FIGS. 4a-c differs from the non-imaging grating compressor 6 shown in FIG. 2a in that the first transmission diffraction grating 7a is formed at an exit-side side of the first transparent substrate 9a. This is advantageous since this makes it possible to avoid the compression of the laser pulses 3 already being implemented in the first transparent substrate 9a. Especially for the case where the grating stretcher 12 generates sufficient temporal stretching of the pulse duration Δτ of the laser pulses 3 by a factor of more than 2 or 5, for example, the non-imaging grating stretcher 6 shown in FIG. 2a can also be used in the compression device 5 shown in FIGS. 5a-c.

As is likewise evident from FIGS. 4a-c, both the grating stretcher 12 and the non-imaging grating compressor 6 are each arranged in a dedicated chamber 15a,b, which can be evacuated in the example shown. The grating stretcher 12 and the grating compressor 6 are consequently situated in surroundings in the interior of the respective chamber 15a,b that is sealed in gas-tight fashion, to which a vacuum can be applied. It is understood that a protective gas can be introduced, alternatively or additionally, into the respective chamber 15a,b, which protective gas may be a noble gas or optionally nitrogen, for example. Arranging the optical components of the compression device 5 in vacuum surroundings or in protective gas surroundings is advantageous, especially in the case of the imaging grating stretcher 12, since an intermediate focus is generated in the central plane M in the case of 4f imaging, and high power densities may occur here. It is understood that this also applies analogously to the imaging grating compressor 6′ described in FIGS. 3a,b. It is likewise understood that the grating compressor 6 and the grating stretcher 12 need not necessarily be accommodated in two different chambers 15a,b, but that these may also be arranged in a common (vacuum) chamber.

The compression device 5 shown in FIG. 4a differs from the compression device 5 shown in FIG. 4b in that the diffraction gratings 7a′, 7b′ of the non-imaging grating compressor 6 and the diffraction gratings 13a′, 13b′ of the grating stretcher 12 are aligned relative to one another so as to minimize a spatial chirp in the case of the compression device 5 shown in FIG. 4a, while this is not the case in the compression device 5 depicted in FIG. 4b. Minimizing the spatial chirp is explained in more detail further below in the context of FIGS. 5a,b.

The compression device 5 depicted in FIG. 4c differs from the compression device 5 shown in FIGS. 4a,b in that two dispersive mirrors 16a,b are arranged downstream of the grating compressor 6 in the beam path 8 of the high-energy laser pulses 3. This is advantageous, in particular, if the grating compressor 6 does not generate complete compensation of the temporal chirp or the (positive) dispersion by way of the self-phase modulation, for example because the grating compressor 6, more precisely the distance d, is too short to reach the minimally possible pulse duration Δτₖ of the high-energy laser pulses 3. In this case, complete compression of the high-energy laser pulses 3 can be achieved with the aid of one or two dispersive mirrors 16a,b. The dispersive mirrors 16a,b may also serve to compensate higher order dispersion effects (e.g., β₃, β₄, β₅ . . . ), which cannot be compensated or which can only be compensated with difficulties by diffraction gratings 7a, 7b. The dispersive mirrors 16a,b may also be arranged upstream of the grating compressor 6 or upstream of the grating stretcher 12 in the beam path 8.

FIGS. 5a,b each show a compression device 5, which is designed analogous to the compression device 5 shown in FIGS. 4a,b, with the transmission diffraction gratings 13a, 13b of the grating stretcher 12 having been replaced by reflection diffraction gratings 13a′, 13b′. Accordingly, the transmission diffraction gratings 7a, 7b of the non-imaging grating compressor 6 have also been replaced by reflection diffraction gratings 7a′, 7b′. The compression device 5 shown in FIG. 5a and the one shown in FIG. 5b differ from one another in that the diffraction gratings 7a′, 7b′ of the non-imaging grating compressor 6 and the diffraction gratings 13a′, 13b′ of the grating stretcher 12 are aligned relative to one another so as to minimize a spatial chirp in the case of the compression device 5 shown in FIG. 5a, while this is not the case in the compression device 5 depicted in FIG. 5b.

In the case of a single pass-through, the spatial chirp arises by way of a pair of diffraction gratings 13a′, 13b′, which have as a consequence a split of the high-energy laser pulses 3 into spectral components which propagate with a spatial offset but in parallel following the single pass-through. The spatial chirp generated by a first pair of diffraction gratings 13a′, 13b′ can be minimized or substantially compensated by one pass-through by way of a further pair of diffraction gratings, in the form of the diffraction gratings 7a′, 7b′ of the non-imaging grating compressor 6 in the example shown, should these generate an opposing spatial chirp of approximately the same magnitude. This can be achieved by way of a suitable alignment relative to one another of the two pairs of reflection diffraction gratings 7a′, 7b′ and 13a′, 13b′, respectively, or of the transmission diffraction gratings 7a, 7b, 13a, 13b of FIG. 4a. In this case, the second pair of diffraction gratings 7a′, 7b′ or 7a, 7b has approximately the same effect in view of the spatial chirp like the case where the high-energy laser beams 3 are reflected at a retroreflector following the single pass through the diffraction gratings 13a′, 13b′ or 13a, 13b of the grating stretcher 12 and pass through the two diffraction gratings 13a′, 13b′ or 13a, 13b of the grating stretcher 12 again.

Since the compression device 5 only needs to compensate a comparatively small temporal chirp which is generated during the self-phase modulation, it may optionally also be possible to dispense with compensation of the spatial chirp, as is the case in the imaging grating compressors 6′ shown in FIGS. 3a,b.

It is understood that the imaging grating compressor 6 and the imaging grating stretcher 12 need not necessarily generate 4f imaging. Where applicable, an intermediate focus in the imaging is not mandatory either if a different type of imaging is implemented, for example in the form of Galileo-like imaging. It is likewise understood that combinations of a grating stretcher 12 operated in transmission and a grating compressor 6 operated in reflection or of a grating stretcher 12 operated in reflection and a grating compressor 6 operated in transmission are also possible.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A laser system for nonlinear pulse compression, comprising:
a laser source configured to generate laser pulses with a pulse energy of at least 50 mJ;
a spectral broadening device for spectrally broadening the high-energy laser pulses using self-phase modulation; and
a compression device including a grating compressor having at least two diffraction gratings and configured to compress the spectrally broadened high-energy laser pulses,
wherein the laser system is configured to generate a pulse duration of the high-energy laser pulses of less than 100 fs.

2. The laser system as claimed in claim 1, wherein the grating compressor is an imaging grating compressor.

3. The laser system as claimed in claim 2, wherein the two diffraction gratings are reflection diffraction gratings.

4. The laser system as claimed in claim 2, wherein the two diffraction gratings are transmission diffraction gratings, each attached to an exit-side side of a respective transparent substrate.

5. The laser system as claimed in claim 1, wherein the compression device comprises a stretching device having at least two stretcher diffraction gratings, configured to temporally stretch the high-energy laser pulses.

6. The laser system as claimed in claim 5, wherein the grating compressor is a non-imaging grating compressor.

7. The laser system as claimed in claim 6, wherein the at least two diffraction gratings are reflection diffraction gratings.

8. The laser system as claimed in claim 6, wherein the at least two diffraction gratings are transmission diffraction gratings.

9. The laser system as claimed in claim 8, wherein a first transmission diffraction grating is attached to an exit-side side or to an entrance-side side of a first transparent substrate and wherein a second transmission diffraction grating is attached to an exit-side side of a second transparent substrate.

10. The laser system as claimed in claim 5, wherein the at least two diffraction gratings are reflection diffraction gratings.

11. The laser system as claimed in claim 8 wherein the at least two stretcher transmission gratings include a first transmission diffraction grating disposed in the beam path and attached to an exit-side side of a first transparent substrate.

12. The laser system as claimed in claim 5, wherein the diffraction gratings of the grating compressor and the stretcher diffraction gratings of the grating stretcher are aligned relative to one another so as to minimize a spatial chirp.

13. The laser system as claimed in claim 1, wherein the compression device comprises at least one dispersive mirror.

14. The laser system as claimed in claim 1 wherein the laser source is designed to generate the high-energy laser pulses with a pulse duration of 300 fs or more.

15. The laser system as claimed in claim 1, wherein the grating compressor and/or the imaging grating stretcher are disposed in a chamber with vacuum surroundings and/or with protective gas surroundings.

16. An imaging grating compressor, comprising:
two transparent substrates,
two transmission diffraction gratings, each attached to an exit side of a respective one of the two transparent substrates, and
an imaging optical unit disposed between the transmission diffraction gratings,
